(19) United States
(12) Patent Application Publication
(10) Pub. No.: US 2025/0073797 A1
(43) Pub. Date: Mar. 6, 2025

(54) Electrical Discharge Machine and Tool Thereof

(71) Applicant: National Kaohsiung University of Science and Technology, Kaohsiung City (TW)

(72) Inventors: WEN-JENG HSUE, Kaohsiung City (TW); CHENG-RUI TANG, Kaohsiung City (TW)

(21) Appl. No.: 18/822,012

(22) Filed: Aug. 30, 2024

(30) Foreign Application Priority Data
Aug. 31, 2023 (TW) 112133073

(51) Int. Cl. B23H 1/10

(52) U.S. Cl. CPC B23H 1/10

(57) ABSTRACT

An electrical discharge machine and tool thereof, and the electrical discharge machine can provide the tool with EDM fluid to perform EDM processing on a workpiece within an EDM discharge channel. The tool comprises an inner flow path that can guide the flow of EDM fluid. The inner flow path can also change the flow speed and flow direction of the EDM fluid, allowing the EDM fluid to laterally flush and discharge the debris in the EDM discharge channel to help remove the debris from the EDM discharge channel, and the specific flow field drives the debris away from the EDM discharge channel, thereby preventing the accumulation of debris that could cause short circuits or abnormal discharges between the electrodes.

### CROSS-REFERENCE TO RELATED APPLICATIONS

This application claims the priority of Republic of China Patent Application No. 112133073 filed on Aug. 31, 2023, in the State Intellectual Property Office of the R.O.C., the disclosure of which is incorporated herein by reference.

### BACKGROUND OF THE INVENTION

### Field of the Invention

This application relates to the technical field of electrical discharge machines, and more specifically, it pertains to an electrical discharge machining and tool thereof, which can enhance the efficiency of debris removal in the EDM discharge channel, ensuring that the roughness, morphology, and dimensional accuracy of the machined areas of the workpiece meet the expected standards.

### Descriptions of the Related Art

Electrical discharge machining (EDM) is a metalworking technique that uses arc discharge within the EDM discharge channel to machine metals. It is particularly suited for the precision machining of complex shapes and difficult-to-cut conductive materials. During the EDM process, arc discharge causes the material of the workpiece to melt and splatter, producing debris. When performing EDM of deep holes, especially in blind holes or micro-holes with small diameter, debris often accumulates in the discharge channel. This accumulation cannot be effectively removed due to vortex regions caused by the EDM fluid. The accumulated debris frequently leads to short circuits and abnormal discharges between the electrodes within the discharge channel, resulting in poor EDM efficiency and suboptimal roughness, morphology, and dimensional accuracy of the machined areas of the workpiece, enabling to cause the rapid dulling and excessive wear of the EDM tool's terminal.

In view of this, the present application provides an electrical discharge machining and tool thereof designed to improve the efficiency of debris removal in the EDM discharge channel, thereby addressing the technical challenges arising from debris accumulation in the EDM discharge channel.

### SUMMARY OF THE INVENTION

In view of the drawbacks of the prior art mentioned above, the present application provides a tool, enabling to be equipped with an EDM fluid on an electrical discharge machine to perform electrical discharge machining on a workpiece, comprising: a tool body; a tool terminal, located at one end of the tool body, and the tool terminal comprises a tool terminal machining surface and a tool terminal primary inner flow path outlet; a tool machining structure, positioned on the exterior of the tool body, and the tool machining structure avoids the tool terminal primary inner flow path outlet and extends along the tool terminal machining surface, wherein the tool terminal and the tool machining structure are integrally formed; and a tool primary inner flow path, penetrating the tool body and extending to the tool terminal primary inner flow path outlet in the interior of the too body, and the tool primary inner flow path comprises a primary inner flow path spiral structure; wherein, the tool body can be positioned close to the workpiece to form an EDM discharge channel between the tool body and the workpiece, allowing the tool machining structure to perform electrical discharge machining on the workpiece in the EDM discharge channel, wherein, a debris is produced in the EDM discharge channel while the tool machining structure performs electrical discharge machining on the workpiece; the tool primary inner flow path can guide the primary portion of the EDM fluid to flow within it; and the tool primary inner flow path spiral structure can change the flow speed and flow direction of the primary portion of the EDM fluid, causing the primary portion of the EDM fluid to deviate from the flow direction of the tool primary inner flow path, and the flow direction of the tool primary inner flow path is inclined related to the extension direction of the tool axis, allowing the primary portion of the EDM fluid to generate a primary inner flow path flow field in the tool primary inner flow path, thereby forming the flow driving the debris out of the EDM discharge channel via the primary inner flow path flow field, wherein the tool primary inner flow path comprises a primary inner flow path body, a primary inner flow path inlet section, and a primary inner flow path outlet section, and the two ends of the tool primary inner flow path body are respectively connected to the tool primary inner flow path inlet section and the tool primary inner flow path outlet section, allowing the primary portion of the EDM fluid flows into the tool primary inner flow path body through the tool primary inner flow path inlet section and exits the tool primary inner flow path body through the tool primary inner flow path outlet section and the tool terminal primary inner flow path outlet, and the tool primary inner flow path spiral structure is located in the tool primary inner flow path outlet section, and the cross-sectional area of the tool primary inner flow path inlet section is larger than that of the tool primary inner flow path outlet section.

Preferably, the tool said above, further comprises: a tool secondary inner flow path, and the tool terminal further comprises a tool terminal secondary inner flow path outlet, and the tool secondary inner flow path penetrates the tool body and extending to the tool terminal secondary inner flow path outlet in the interior of the tool body, and the tool machining structure is arranged to avoid the tool terminal secondary inner flow path outlet and extends on the tool terminal machining surface, and the tool secondary inner flow path comprises a secondary inner flow path spiral structure, and the secondary inner flow path spiral structure is separate from the tool primary inner flow path spiral structure; the tool secondary inner flow path can direct the secondary portion of the EDM fluid within it; and the secondary inner flow path spiral structure can change the flow speed and flow direction of the secondary portion of the EDM fluid, causing the secondary portion of the EDM fluid to deviate from the flow direction of the tool secondary inner flow path, and the flow direction of the tool secondary inner flow path is inclined related to the extension direction of the tool axis, allowing the secondary portion of the EDM fluid to generate a secondary inner flow path flow field in the tool secondary inner flow path, thereby forming the flow driving the debris out of the EDM discharge channel via the secondary inner flow path flow field.

Preferably, the tool said above, wherein the tool secondary inner flow path comprises a secondary inner flow path body, a secondary inner flow path inlet section, and a secondary inner flow path outlet section, and the two ends of the secondary inner flow path body are respectively connected to the secondary inner flow path inlet section and the secondary inner flow path outlet section, allowing the secondary portion of the EDM fluid to flow into the secondary inner flow path body through the secondary inner flow path inlet section and exit the secondary inner flow path body through the secondary inner flow path outlet section and the tool terminal secondary inner flow path outlet, and the secondary inner flow path spiral structure is located within the secondary inner flow path outlet section, and the cross-sectional area of the secondary inner flow path inlet section is larger than the cross-sectional area of the secondary inner flow path outlet section; the tool primary inner flow path inlet section and the secondary inner flow path inlet section are communicable, wherein the total cross-sectional area at the junction of the tool primary inner flow path inlet section and the secondary inner flow path inlet section is larger than the total cross-sectional area of the tool primary inner flow path outlet section and the secondary inner flow path outlet section.

Preferably, the tool said above, further comprising a tool outer flow path, and the tool outer flow path is installed on the exterior of the tool body, and the tool outer flow path comprises an outer flow path guiding structure, and the outer flow path guiding structure comprises a debris channel, and the outer flow path guiding structure is capable of changing the flow speed and flow direction of the EDM fluid within the EDM discharge channel, thereby generating an outer flow path flow field within the EDM discharge channel, thereby forming the flow driving the debris out of the EDM discharge channel via the debris channel, and the debris channel is the groove of the tool body.

Additionally, the present application provides an electrical discharge machine, the electrical discharge machine being capable of providing an EDM fluid and being equipped with the tool described in claim 1 for performing electrical discharge machining on a workpiece, the electrical discharge machine comprising: an EDM spindle, being used for mounting the tool and being capable of moving the tool body close to the workpiece, and the EDM spindle comprises a machining fluid injection structure and a rotational power source; wherein, the machining fluid injection structure is capable of injecting the primary portion of the EDM fluid into the tool primary inner flow path; and the rotational power source is capable of rotating the tool, thereby changing the flow speed and flow direction of the primary portion of the EDM fluid, causing the primary portion of the EDM fluid to deviate from the flow direction of the tool primary inner flow path, and the flow direction of the tool primary inner flow path is inclined related to the extension direction of the tool axis, allowing the primary portion of the EDM fluid to generate a primary inner flow path flow field in the EDM discharge channel between the tool body of the tool and the workpiece, thereby forming the flow driving the debris generated in the EDM discharge channel out of the EDM discharge channel via the primary inner flow path flow field.

Additionally, the present application provides a tool, enabling to be equipped with an EDM fluid on an electrical discharge machine to perform electrical discharge machining on a workpiece, comprising: a tool body, the tool body extending along a tool axis; a tool machining structure, the tool machining structure being positioned on the exterior of the tool body; and a tool primary inner flow path, the tool primary inner flow path extending through the interior of the tool body and penetrating the tool body, and the tool primary inner flow path comprises a primary inner flow path straight extension section and at least one primary inner flow path oblique extension section, and the tool primary inner flow path straight extension section is connected to the tool primary inner flow path oblique extension section, and the extension direction of the tool primary inner flow path straight extension section is parallel to the extension direction of the tool axis, and the extension direction of the tool primary inner flow path oblique extension section is inclined relative to the extension direction of the tool axis, and the tool primary inner flow path oblique extension section extends along the tangential direction of a spiral structure; wherein, the tool body can be positioned close to the workpiece to form an EDM discharge channel between the tool body and the workpiece, allowing the tool machining structure to perform electrical discharge machining on the workpiece in the EDM discharge channel, wherein, a debris is produced in the EDM discharge channel while the tool machining structure performs electrical discharge machining on the workpiece; the tool primary inner flow path straight extension section can guide the primary portion of the EDM fluid to flow within it; and the tool primary inner flow path oblique extension section can change the flow speed and flow direction of the primary portion of the EDM fluid, causing the primary portion of the EDM fluid to deviate from the flow direction of the tool primary inner flow path, and the flow direction of the tool primary inner flow path is inclined related to the extension direction of the tool axis, thereby generating a primary inner flow path flow field in the EDM discharge channel, thereby forming the flow driving the debris out of the EDM discharge channel via the primary inner flow path flow field.

Preferably, the tool said above, further comprises a tool secondary inner flow path, the tool secondary inner flow path extending through the interior of the tool body and penetrating the tool body, and the tool secondary inner flow path comprises a secondary inner flow path straight extension section and at least one secondary inner flow path oblique extension section, and the secondary inner flow path oblique extension section avoids the tool primary inner flow path oblique extension section, and the secondary inner flow path straight extension section is connected to the secondary inner flow path oblique extension section, and the extension direction of the secondary inner flow path straight extension section is parallel to the extension direction of the tool axis, and the extension direction of the secondary inner flow path oblique extension section is inclined relative to the extension direction of the tool axis, and the secondary inner flow path oblique extension section extends along the tangential direction of a spiral structure; wherein, the secondary inner flow path straight extension section can guide the secondary portion of the EDM fluid to flow within it; and the secondary inner flow path oblique extension section can change the flow speed and flow direction of the secondary portion of the EDM fluid, causing the secondary portion of the EDM fluid to deviate from the flow direction of the tool secondary inner flow path, and the flow direction of the tool secondary inner flow path is inclined related to the extension direction of the tool axis, thereby generating a secondary inner flow path flow field in the EDM discharge channel, thereby forming the flow driving the debris out of the EDM discharge channel via the secondary inner flow path flow field.

Preferably, the tool said above, further comprises: a tool outer flow path, and the tool outer flow path is installed on the exterior of the tool body, and the tool outer flow path comprises an outer flow path guiding structure, and the outer flow path guiding structure comprises a debris channel, and the outer flow path guiding structure is capable of changing the flow speed and flow direction of the EDM fluid within the EDM discharge channel, thereby generating an outer flow path flow field within the EDM discharge channel, thereby forming the flow driving the debris out of the EDM discharge channel via the debris channel, and the debris channel is the groove of the tool body.

Additionally, the present application provides an electrical discharge machine,, the electrical discharge machine being capable of providing an EDM fluid and being equipped with the tool described in claim 6 for performing electrical discharge machining on a workpiece, the electrical discharge machine comprising: an EDM spindle, being used for mounting the tool and being capable of moving the tool body close to the workpiece, and the EDM spindle comprises a machining fluid injection structure and a rotational power source; wherein, the machining fluid injection structure is capable of injecting the primary portion of the EDM fluid into the tool primary inner flow path; and the rotational power source is capable of rotating the tool, thereby changing the flow speed and flow direction of the primary portion of the EDM fluid, causing the primary portion of the EDM fluid to deviate from the flow direction of the tool primary inner flow path, and the flow direction of the tool primary inner flow path is inclined related to the extension direction of the tool axis, allowing the primary portion of the EDM fluid to generate a primary inner flow path flow field in the EDM discharge channel between the tool body of the tool and the workpiece, thereby forming the flow driving the debris generated in the EDM discharge channel out of the EDM discharge channel via the primary inner flow path flow field.

Compared to prior art, the present application provides an electrical discharge machine and tool thereof, and the electrical discharge machine can provide the tool with EDM fluid to perform EDM processing on a workpiece within an EDM discharge channel. The tool comprises an inner flow path that can guide the flow of EDM fluid. The inner flow path can also change the flow speed and flow direction of the EDM fluid, allowing the EDM fluid to laterally flush and discharge the debris in the EDM discharge channel to help remove the debris from the EDM discharge channel, thereby preventing the accumulation of debris that could cause short circuits or abnormal discharges between the electrodes, increasing EDM efficiency and ensuring that the roughness, morphology, and dimensional accuracy of the machined area of the workpiece meet expectations. Additionally, it may even prolong the lifespan of the tool during EDM operations.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic diagram illustrating the operational state of the electrical discharge machine of this application.

FIG. 2 is a schematic diagram illustrating the operational state of the tool (including the tool primary inner flow path and secondary inner flow path) of this application.

FIG. 3 is a schematic diagram illustrating the structure of the tool machining structure (including the tool primary inner flow path and secondary inner flow path) of this application.

FIG. 4 is a schematic diagram illustrating the operational state of the tool (including the tool primary inner flow path) of this application.

FIG. 5 is a schematic diagram illustrating the structure of the tool machining structure (including the tool primary inner flow path) of this application.

FIG. 6 is a schematic diagram illustrating the structure of the tool (including the tool primary inner flow path) of this application.

FIG. 7 is a schematic diagram illustrating the structure of the tool (including the tool primary inner flow path and the tool outer flow path) of this application.

FIG. 8 is a schematic diagram illustrating the structure of the tool (including the tool primary inner flow path and secondary inner flow path) of this application.

FIG. 9 is a schematic diagram illustrating the structure of the tool (including the tool primary inner flow path, secondary inner flow path, and tool outer flow path) of this application.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

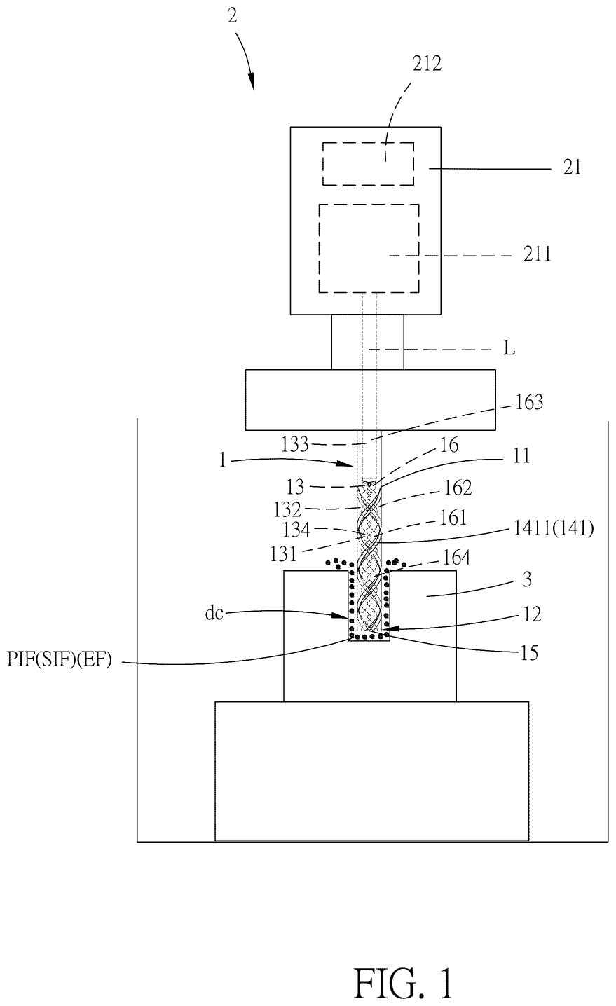

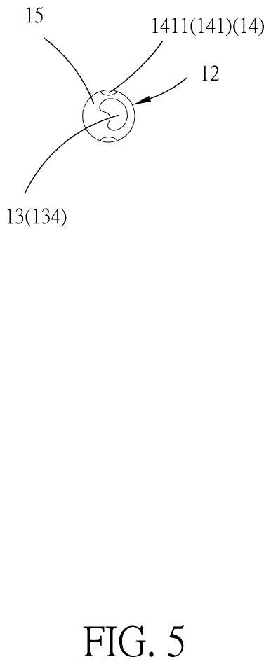

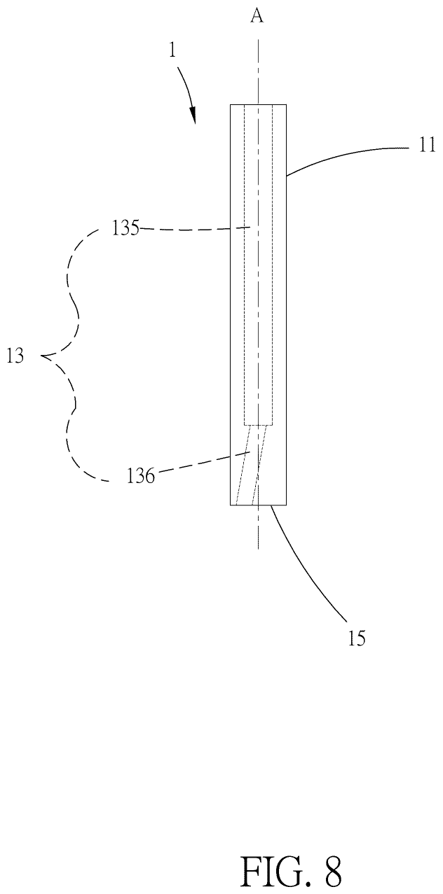

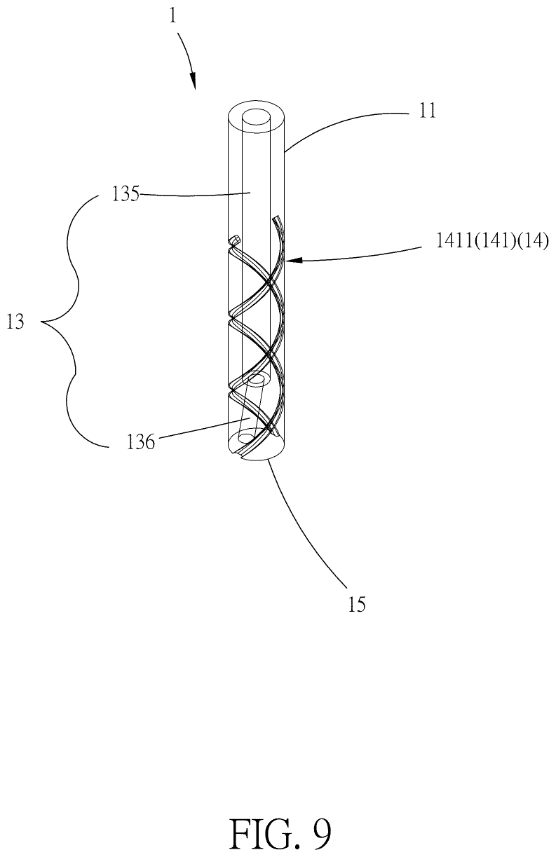

For a detailed description of the embodiments disclosed in the present application, please refer to FIGS. 1 to 9.

As shown in the embodiment in FIG. 1, this application provides an electrical discharge machine 2 and tool 1 thereof. The electrical discharge machine 2 can provide an EDM fluid L and be equipped with the tool 1 to perform flushing-type electrical discharge machining on a workpiece 3. The electrical discharge machine 2 comprises an EDM spindle 21, and the EDM spindle 21 is used to install a tool 1 and can move the tool 1 closer to the workpiece 3.

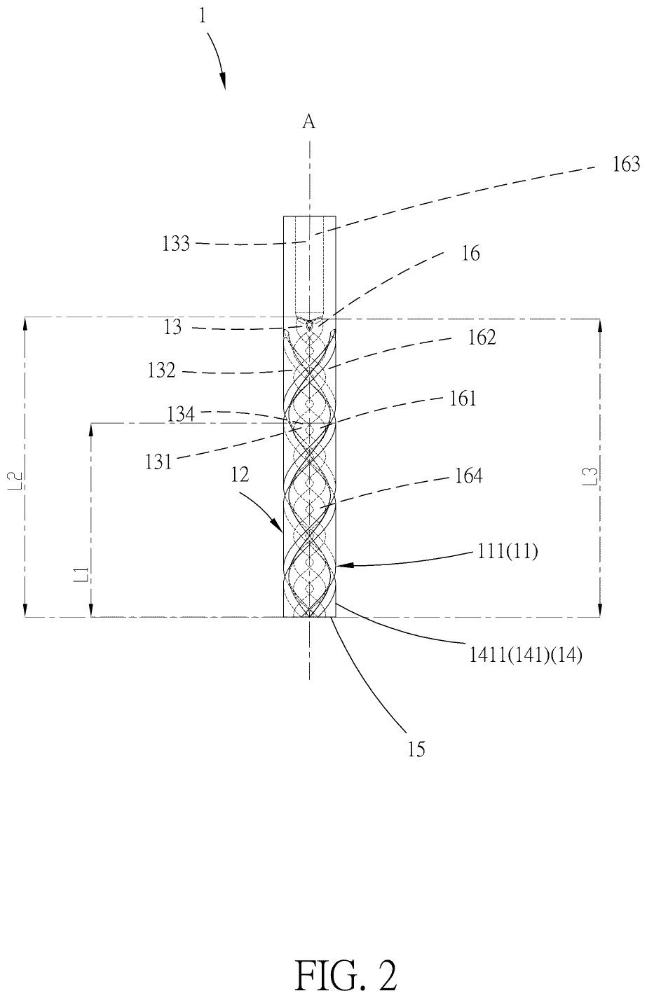

As shown in FIGS. 2 to 5, the tool 1 comprises a tool body 11, a tool machining structure 12, a tool primary inner flow path 13, and a tool terminal 15. The EDM spindle 21 comprises a machining fluid injection structure 211 and a rotational power source 212. The machining fluid injection structure 211 can inject the primary portion of the EDM fluid L into the tool primary inner flow path 13. The rotational power source 212 can rotate the tool 1, allowing the tool Ito perform electrical discharge machining on the workpiece 3 while the tool 1 rotates.

The tool body 11 extends along a tool axis A, and the tool machining structure 12 is installed on the outside of the tool body 11. The tool terminal 15 is situated at one end of the tool body 11, and the tool terminal 15 comprises a tool terminal machining surface 151, a tool terminal primary inner flow path outlet 152, and a tool terminal secondary inner flow path outlet 153. The tool machining structure 12 extends along the tool terminal machining surface 151, avoiding the tool terminal primary inner flow path outlet 152 and the tool terminal secondary inner flow path outlet 153. This design increases the extension area of the tool machining structure 12, thereby enhancing the efficiency of electrical discharge machining. Additionally, the tool terminal 15 and the tool machining structure 12 are integrally formed to reduce the wear of the tool 1 during electrical discharge machining.

Additionally, the EDM spindle 21 can move the tool 1 so that the tool body 11 approaches the workpiece 3, forming an EDM discharge channel dc (discharge channel) between the tool body 11 and the workpiece 3, allowing the tool machining structure 12 to perform electrical discharge machining on the workpiece 3 within the EDM discharge channel dc. The EDM discharge channel dc is located in the gap between the tool terminal 15 or the side wall of the tool 1 and the workpiece 3. It should be noted that when the tool machining structure 12 performs electrical discharge machining on the workpiece 3, debris will be generated in the EDM discharge channel dc.

The tool primary inner flow path 13 penetrates the tool body 11 and extends to the tool terminal primary inner flow path outlet 152 from the interior of the tool body 11. The tool primary inner flow path 13 can guide the primary portion of the EDM fluid L to flow through it. In the described embodiment, the tool primary inner flow path 13 comprises a primary inner flow path spiral structure 131. When the tool 1 rotates, the tool primary inner flow path spiral structure 131 rotates with the tool 1, altering the flow speed and flow direction of the primary portion of the EDM fluid L, causing the primary portion of the EDM fluid L to deviate from the flow direction of the tool primary inner flow path, and the flow direction is inclined relative to the extension direction of the tool axis A, allowing the primary portion of the EDM fluid L generates a primary inner flow path flow field PIF (primary inner flow path flow field) within the tool primary inner flow path 13, forming a fluid that drives the debris away from the EDM discharge channel de via the primary inner flow path flow field PIF. It should be noted that the fluid, which drives the debris away from the EDM discharge channel dc, can laterally flush out the debris from the EDM discharge channel dc, thereby improving the efficiency of debris removal within the EDM discharge channel dc and addressing the technical issue of debris accumulation within the EDM discharge channel dc.

Optionally, the tool primary inner flow path spiral structure 131 is a helical conduit structure, and the angle of the spiral lead angle of the tool primary inner flow path spiral structure 131 is greater than 15 degrees, less than 60 degrees, or less than 75 degrees, allowing the primary portion of the EDM fluid L to laterally flush the EDM discharge channel de at the aforementioned spiral lead angle, thereby laterally flushing out the debris in the EDM discharge channel dc, preventing the primary portion of the EDM fluid L from creating a vortex zone in the EDM discharge channel dc, thus improving the efficiency of debris removal by the primary portion of the EDM fluid L in the EDM discharge channel dc.

The tool terminal 15 is located at one end of the tool body 11, and the tool body 11 comprises a tool permissible wear area 111. The tool permissible wear area 111 is the part of the tool body 11 that is allowed to wear during the electrical discharge machining process. The tool permissible wear area 111 extends upward from the tool terminal 15. In the described embodiment, the straight length of the tool permissible wear area 111 is referred to as the tool permissible wear straight length L1.

In the described embodiment, the tool machining structure 12 extends upward from the tool terminal 15, and the straight length of the tool machining structure 12 is referred to as the tool permissible wear straight length L1. The tool primary inner flow path spiral structure 131 also extends upward from the tool terminal 15, and the straight length of the tool primary inner flow path spiral structure 131 is referred to as the tool primary inner flow path spiral structure straight length L2. It should be noted that the tool primary inner flow path spiral structure straight length L2 is greater than the tool permissible wear straight length L1. Therefore, even if the tool machining structure 12 is trimmed or cut to make the shape of the tool terminal 15 meet the requirements of electrical discharge machining, the tool primary inner flow path 13 can still retain the tool primary inner flow path spiral structure 131.

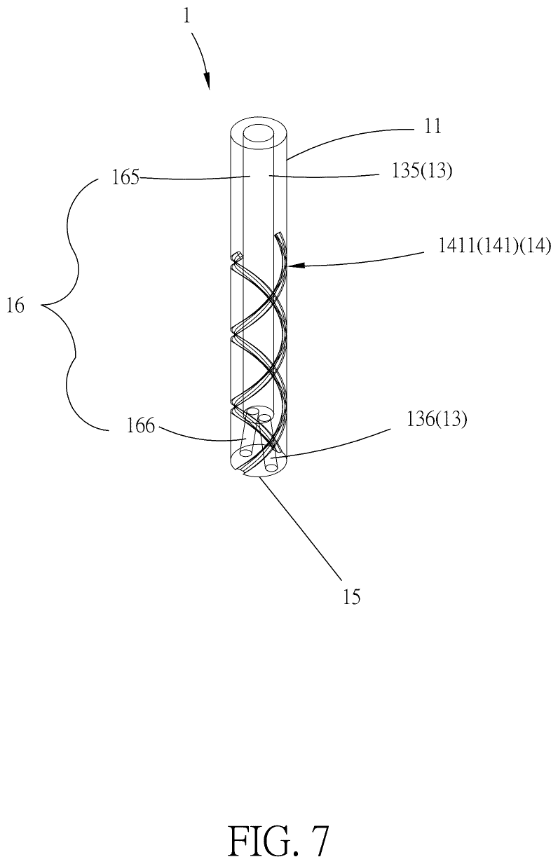

In the embodiment shown in FIG. 7, the tool primary inner flow path 13 comprises a primary inner flow path straight extension section 135 and at least one primary inner flow path oblique extension section 136. The tool primary inner flow path straight extension section 135 connects to the tool primary inner flow path oblique extension section 136. The extension direction of the tool primary inner flow path straight extension section 135 is parallel to the extension direction of the tool axis A. The extension direction of the tool primary inner flow path oblique extension section 136 is inclined relative to the extension direction of the tool axis A.

It should be noted that the tool primary inner flow path straight extension section 135 can guide the primary portion of the EDM fluid L to flow toward the tool primary inner flow path oblique extension section 136 in the tool primary inner flow path straight extension section 135, while the tool primary inner flow path oblique extension section 136 extends along the tangent direction of the helical structure. When the tool 1 rotates, the tool primary inner flow path oblique extension section 136 rotates with the tool 1, altering the flow speed and flow direction of the primary portion of the EDM fluid L, causing the primary portion of the EDM fluid L to deviate from the flow direction of the tool primary inner flow path 13, and the flow direction is incline relative to the extension direction of the tool axis A, allowing the primary portion of the EDM fluid L to laterally flush the EDM discharge channel dc along a predetermined flow speed and flow direction, avoiding the primary portion of the EDM fluid L causing the vortex zones within the EDM discharge channel dc, and generating a primary inner flow path flow field PIF (primary inner flow path flow field) within the tool primary inner flow path 13. The primary inner flow path flow field PIF forms a fluid that drives the debris away from the EDM discharge channel dc.

Optionally, the number of primary inner flow path oblique extension sections 136 can be multiple. When the tool primary inner flow path oblique extension sections 136 rotate along with the tool 1, the tool primary inner flow path oblique extension sections 136 can cause the flow speed and flow direction of the primary portion of the EDM fluid L to change multiple times to ensure that the flow speed and flow direction of the primary portion of the EDM fluid L meet the expected values, allowing the primary portion of the EDM fluid L to laterally flush the EDM discharge channel dc along the predetermined flow speed and flow direction.

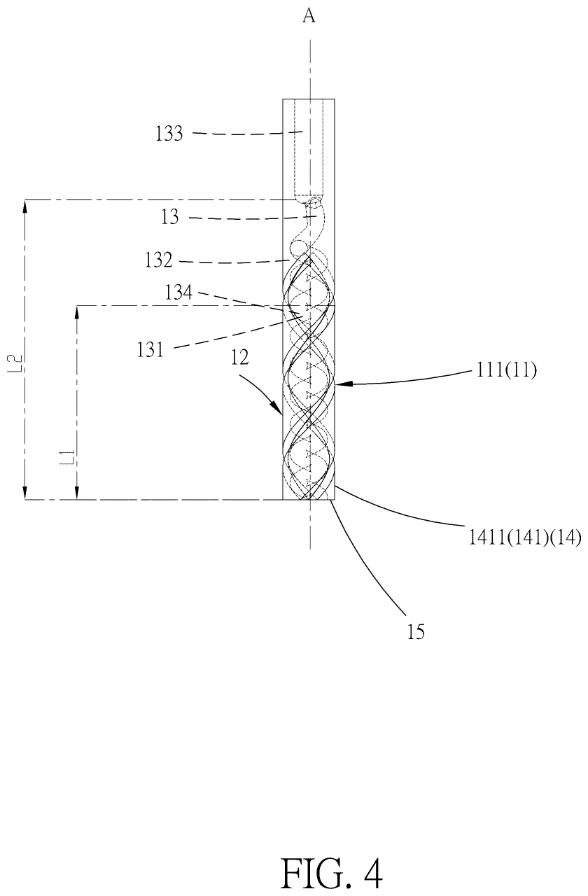

Furthermore, in the embodiment shown in FIG. 4, the tool primary inner flow path 13 comprises a primary inner flow path body 132, a primary inner flow path inlet section 133, and a primary inner flow path outlet section 134. Both ends of the tool primary inner flow path body 132 are connected to the tool primary inner flow path inlet section 133 and the tool primary inner flow path outlet section 134, respectively, allowing the primary portion of the EDM fluid L to flow into the tool primary inner flow path body 132 through the tool primary inner flow path inlet section 133, and then flow out of the tool primary inner flow path body 132 through the tool primary inner flow path outlet section 134 and the tool terminal primary inner flow path outlet 152.

In the aforementioned embodiment, the tool primary inner flow path spiral structure 131 is located in the tool primary inner flow path outlet section 134. This means that only a segment of the tool primary inner flow path 13 comprises a spiral structure, effectively reducing the extension length of the tool primary inner flow path spiral structure 131, minimizing the pressure drop (head loss) as the primary portion of the EDM fluid L flows through the tool primary inner flow path spiral structure 131, ensuring that the flow speed of the primary portion of the EDM fluid L exiting the tool primary inner flow path body 132 meets the expected value. The cross-sectional area of the tool primary inner flow path inlet section 133 is larger than the cross-sectional area of the tool primary inner flow path outlet section 134, causing the primary portion of the EDM fluid L to accelerate in the tool primary inner flow path outlet section 134. Consequently, the flow speed of the primary portion of the EDM fluid L in the tool primary inner flow path outlet section 134 is greater than that in the tool primary inner flow path inlet section 133, allowing the primary portion of the EDM fluid L to laterally flush and discharge the debris from the EDM discharge channel de after exiting the tool primary inner flow path 13, preventing the formation of vortex zones in the EDM discharge channel dc by the primary portion of the EDM fluid L, thereby enhancing the debris removal efficiency of the primary portion of the EDM fluid L within the EDM discharge channel dc, preventing inter-electrode short circuits and abnormal discharges caused by debris in the EDM discharge channel dc, ultimately improving the efficiency of EDM processing while ensuring that the roughness, morphology, and dimensional accuracy of the processed areas of the workpiece 3 meet expectations. Additionally, this solution addresses the issue of rapid passivation and excessive wear at the tool terminal 15 during electrical discharge machining processing.

Optionally, the distance between the center of the tool primary inner flow path spiral structure 131 and the center of the tool body 11 is greater than the radius of the tool primary inner flow path spiral structure 131. Additionally, the lead of the tool primary inner flow path spiral structure 131 is greater than inner diameter of the tool primary inner flow path spiral structure 131, ensuring that the flow speed of the primary portion of the EDM fluid L in the tool primary inner flow path outlet section 134 meets expectations, and that the structural strength of the tool body 11 is also as expected.

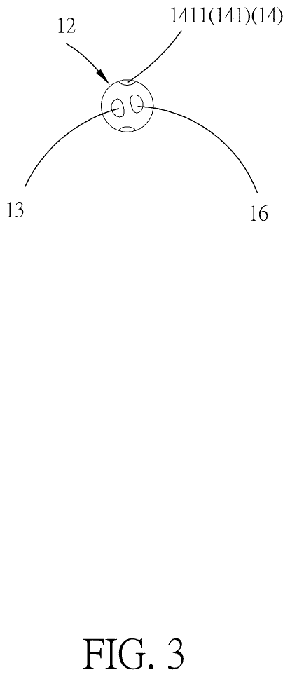

In the embodiments shown in FIGS. 2 and 3, the tool 1 also comprises a tool secondary inner flow path 16, and the tool secondary inner flow path 16 penetrates the tool body 11 and extends to the tool terminal secondary inner flow path outlet 153 from the interior of the tool body 11. The tool secondary inner flow path 16 comprises a secondary inner flow path spiral structure 161, and the secondary inner flow path spiral structure 161 is positioned away from the tool primary inner flow path spiral structure 131. Optionally, the number of secondary inner flow paths 16 may be multiple.

The machining fluid injection structure 211 can inject the secondary portion of the EDM fluid L into the tool secondary inner flow path 16. The tool secondary inner flow path 16 can guide the secondary portion of the EDM fluid L to flow within it. When the tool 1 rotates, the secondary inner flow path spiral structure 161 can rotate along with the tool 1, altering the flow speed and flow direction of the secondary portion of the EDM fluid L, causing the secondary portion of the EDM fluid L to flow out of the flow direction of the tool secondary inner flow path 16, and the flow direction is inclined related to the extension direction of the tool axis A, generating a secondary inner flow path flow field SIF (secondary inner flow path flow field) within the tool secondary inner flow path 16. The secondary inner flow path flow field SIF forms a fluid that drives debris out of the EDM discharge channel dc. It should be noted that this fluid, which drives the debris out of the EDM discharge channel dc, can laterally flush out the debris, thereby improving the debris removal efficiency within the EDM discharge channel dc and addressing the technical issue of debris accumulation in the discharge channel.

Optionally, the secondary inner flow path spiral structure 161 is a helical conduit structure, and the angle of the spiral lead angle of the secondary inner flow path spiral structure 161 is greater than 20 degrees, or equal to 20 degrees, but less than 75 degrees, allowing the secondary portion of the EDM fluid L to laterally flush the EDM discharge channel dc at the aforementioned spiral lead angle, thereby laterally flushing out the debris in the EDM discharge channel dc, preventing the secondary portion of the EDM fluid L from creating a vortex zone in the EDM discharge channel dc, thus improving the efficiency of debris removal by the secondary portion of the EDM fluid L in the EDM discharge channel dc.

It should be noted that, in the described embodiment, the secondary inner flow path spiral structure 161 extends upward from the tool terminal 15, and the straight length of the secondary inner flow path spiral structure 161 is referred to as the secondary inner flow path spiral structure straight length L3. It should be noted that the secondary inner flow path spiral structure straight length L3 is greater than the tool permissible wear straight length L1. Therefore, even if the tool machining structure 12 is trimmed or cut to make the shape of the tool terminal 15 meet the requirements of electrical discharge machining, the tool secondary inner flow path 16 can still retain the secondary inner flow path spiral structure 161.

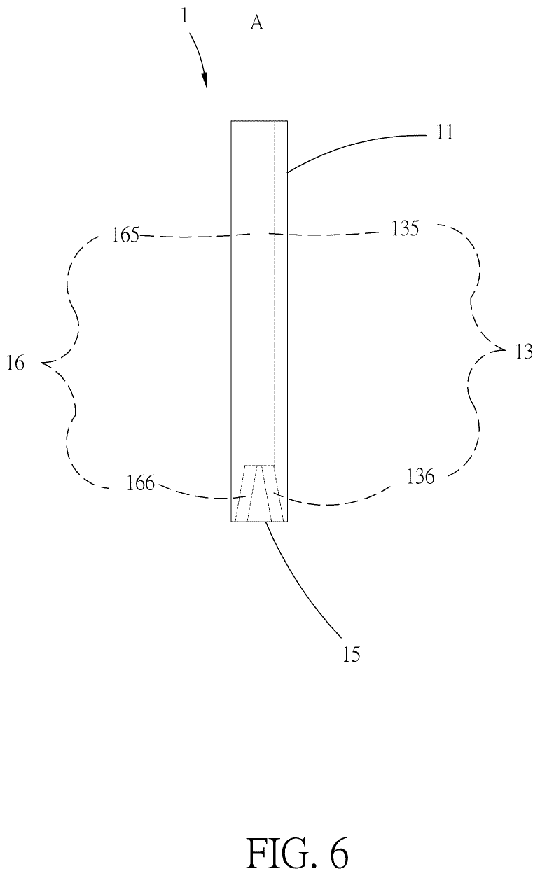

In the embodiment shown in FIG. 6, the tool secondary inner flow path 16 comprises a secondary inner flow path straight extension section 165 and at least one secondary inner flow path oblique extension section 166. The secondary inner flow path straight extension section 165 connects to the secondary inner flow path oblique extension section 166. The extension direction of the secondary inner flow path straight extension section 165 is parallel to the extension direction of the tool axis A. The extension direction of the secondary inner flow path oblique extension section 166 is inclined relative to the extension direction of the tool axis A.

It should be noted that the secondary inner flow path straight extension section 165 can be optionally connected with the secondary inner flow path straight extension section 135, guiding the secondary portion of the EDM fluid L to flow toward the secondary inner flow path oblique extension section 166 in the secondary inner flow path straight extension section 165, while the secondary inner flow path oblique extension section 166 extends along the tangent direction of the helical structure. When the tool 1 rotates, the secondary inner flow path oblique extension section 166 rotates with the tool 1, altering the flow speed and flow direction of the secondary portion of the EDM fluid L, causing the secondary portion of the EDM fluid L to deviate from the flow direction of the tool secondary inner flow path 16, and the flow direction is incline relative to the extension direction of the tool axis A, allowing the secondary portion of the EDM fluid L to laterally flush the EDM discharge channel dc along a predetermined flow speed and flow direction, avoiding the secondary portion of the EDM fluid L causing the vortex zones within the EDM discharge channel dc, and generating a secondary inner flow path flow field SIF (secondary inner flow path flow field) within the tool secondary inner flow path 16. The secondary inner flow path flow field SIF forms a fluid that drives the debris away from the EDM discharge channel dc.

Optionally, the number of secondary inner flow path oblique extension sections 166 can be multiple. When the secondary inner flow path oblique extension sections 166 rotate along with the tool 1, the secondary inner flow path oblique extension sections 166 can cause the flow speed and flow direction of the secondary portion of the EDM fluid L to change multiple times to ensure that the flow speed and flow direction of the secondary portion of the EDM fluid L meet the expected values, allowing the secondary portion of the EDM fluid L to laterally flush the EDM discharge channel dc along the predetermined flow speed and flow direction.

Furthermore, in the embodiment shown in FIG. 2, the tool secondary inner flow path 16 comprises a secondary inner flow path body 162, a secondary inner flow path inlet section 163, and a secondary inner flow path outlet section 164. Both ends of the secondary inner flow path body 162 are connected to the secondary inner flow path inlet section 163 and the secondary inner flow path outlet section 164, respectively, allowing the secondary portion of the EDM fluid L to flow into the secondary inner flow path body 162 through the secondary inner flow path inlet section 163, and then flow out of the secondary inner flow path body 162 through the secondary inner flow path outlet section 164 and the tool terminal secondary inner flow path outlet 153. In the aforementioned embodiment, the secondary inner flow path spiral structure 161 is located in the secondary inner flow path outlet section 164. This means that only a segment of the tool secondary inner flow path 16 comprises a spiral structure, effectively reducing the extension length of the secondary inner flow path spiral structure 161, minimizing the pressure drop (head loss) as the secondary portion of the EDM fluid L flows through the secondary inner flow path spiral structure 161, ensuring that the flow speed of the secondary portion of the EDM fluid L exiting the secondary inner flow path body 162 meets the expected value. The cross-sectional area of the secondary inner flow path inlet section 163 is larger than the cross-sectional area of the secondary inner flow path outlet section 164, causing the flow speed of the secondary portion of the EDM fluid L in the secondary inner flow path outlet section 164 is greater than the flow speed of the secondary inner flow path inlet section 163, allowing the secondary portion of the EDM fluid L to laterally flush and discharge the debris from the EDM discharge channel dc after exiting the tool secondary inner flow path 16, preventing the formation of vortex zones in the EDM discharge channel dc by the secondary portion of the EDM fluid L, thereby enhancing the debris removal efficiency of the secondary portion of the EDM fluid L within the EDM discharge channel dc, addressing the issue of rapid passivation and excessive wear at the tool terminal 15 during electrical discharge machining processing.

Optionally, the tool primary inner flow path inlet section 133 and the secondary inner flow path inlet section 163 can be interconnected, wherein, the combined cross-sectional area of the interconnection between the tool primary inner flow path inlet section 133 and the secondary inner flow path inlet section 163 is greater than the combined cross-sectional area of the tool primary inner flow path outlet section 134 and the secondary inner flow path outlet section 164, ensuring that, after the EDM fluid L exits the tool primary inner flow path 13 and the tool secondary inner flow path 16, the flow speed of the EDM fluid L can laterally flush out debris from the EDM discharge channel dc.

Optionally, the distance between the center of the secondary inner flow path spiral structure 161 and the center of the tool body 11 is greater than the radius of the secondary inner flow path spiral structure 161. Additionally, the lead of the secondary inner flow path spiral structure 161 is greater than inner diameter of the secondary inner flow path spiral structure 161, ensuring that the flow speed of the secondary portion of the EDM fluid L in the secondary inner flow path outlet section 164 meets expectations, and that the structural strength of the tool body 11 is also as expected.

As shown in FIGS. 1 to 5, 7, and 9, the tool 1 also comprises a tool outer flow path 14, which is installed the exterior of the tool body 11. The tool outer flow path 14 comprises an outer flow path guiding structure 141, and the outer flow path guiding structure 141 may be, for example, a straight groove guiding structure, an oblique groove guiding structure, or a spiral guiding structure. When the tool 1 rotates, the outer flow path guiding structure 141 rotates with the tool 1 and guides the EDM fluid L to flow, altering the flow speed and flow direction of the EDM fluid L in the outer flow path guiding structure 141, allowing the EDM fluid L to generate an external flow field EF in the EDM discharge channel dc, forming the flow driving the removal of debris from the EDM discharge channel dc via the external flow field EF, improving the efficiency of debris removal to prevent inter-electrode short circuits and abnormal discharges in the EDM discharge channel dc due to debris accumulation, thus enhancing EDM efficiency and ensuring that the roughness, morphology, and dimensional accuracy of the machined area of the workpiece 3 meet expectations. Additionally, it addresses the issue of excessive wear and passivation at the tool terminal 15 during EDM.

It should be noted that the outer flow path guiding structure 141 comprises a debris channel 1411, wherein the debris can exit the EDM discharge channel dc through the debris channel 1411. The debris channel 1411 is installed within the groove of the tool body 11.

It should be noted that in the embodiments of this application, some of the aforementioned components can be omitted. For example, the tool provided in this application comprises: a tool body, a tool machining structure, and a tool primary inner flow path. The tool machining structure is installed on the exterior of the tool body. The tool primary inner flow path extends through the interior of the tool body and penetrated the tool body, and the tool primary inner flow path comprises a primary inner flow path spiral structure. The tool body can approach the workpiece, forming an EDM discharge channel between the tool body and the workpiece, allowing the tool machining structure to perform electrical discharge machining on the workpiece within the discharge channel. The electrical discharge machining performed by the tool machining structure on the workpiece generates debris in the discharge channel. The tool primary inner flow path guides the primary portion of the EDM fluid to flow through it. The tool primary inner flow path spiral structure changes the flow speed and flow direction of the primary portion of the EDM fluid, causing the primary portion of the EDM fluid to generate a primary inner flow path flow field within the discharge channel, driving the debris out of the discharge channel via the primary inner flow path flow field.

Furthermore, the tool provided in this application comprises: a tool body, a tool machining structure, and a primary inner flow path. The tool body extends along the tool axis. The tool machining structure is installed on the exterior of the tool body. The tool primary inner flow path extends through the interior of the tool body and penetrates the tool body, and the tool primary inner flow path comprises a primary inner flow path straight extension section and at least one primary inner flow path oblique extension section. The tool primary inner flow path straight extension section connects to the tool primary inner flow path oblique extension section. The extension direction of the tool primary inner flow path straight extension section is parallel to the extension direction of the tool axis, while the extension direction of the tool primary inner flow path oblique extension section is inclined relative to the extension direction of the tool axis. The tool body can approach the workpiece, forming an EDM discharge channel between the tool body and the workpiece, allowing the tool machining structure to perform EDM on the workpiece within the discharge channel. EDM performed by the tool machining structure on the workpiece generates debris in the discharge channel. The tool primary inner flow path straight extension section guides the primary portion of the EDM fluid through it. The tool primary inner flow path oblique extension section changes the flow speed and flow direction of the primary portion of the EDM fluid, generating a primary inner flow path flow field within the discharge channel, which drives the debris out of the discharge channel.

Additionally, the electrical discharge machine provided in this application comprises: an EDM spindle. The EDM spindle is used to mount the tool and can move the tool so that the tool body is close to the workpiece. The EDM spindle comprises a machining fluid injection structure and a rotational power source. The machining fluid injection structure injects the primary portion of the EDM fluid into the primary inner flow path of the tool. The rotational power source rotates the tool, causing the primary inner flow path spiral structure to rotate with the tool, thereby changing the flow speed and flow direction of the primary portion of the EDM fluid.

Furthermore, the electrical discharge machine provided by this application comprises: an EDM spindle. The EDM spindle is used to mount the tool and can move the tool to bring the tool body close to the workpiece. The EDM spindle comprises a machining fluid injection structure and a rotational power source. The machining fluid injection structure can inject the primary portion of the EDM fluid into the tool primary inner flow path. The rotational power source can rotate the tool, causing the primary internal flow path oblique extension section to rotate with the tool, thereby changing the flow speed and flow direction of the primary portion of the EDM fluid.

In summary, the present application provides an electrical discharge machine and tool thereof, and the electrical discharge machine can provide the tool with EDM fluid to perform EDM processing on a workpiece within an EDM discharge channel. The tool comprises an inner flow path that can guide the flow of EDM fluid. The inner flow path can also change the flow speed and flow direction of the EDM fluid, allowing the EDM fluid to laterally flush and discharge the debris in the EDM discharge channel to help remove the debris from the EDM discharge channel, thereby preventing the accumulation of debris that could cause short circuits or abnormal discharges between the electrodes, increasing EDM efficiency and ensuring that the roughness, morphology, and dimensional accuracy of the machined area of the workpiece meet expectations. Additionally, it may even prolong the lifespan of the tool during EDM operations.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. A tool, enabling to be equipped with an EDM fluid on an electrical discharge machine to perform electrical discharge machining on a workpiece, comprising:
a tool body;
a tool terminal, located at one end of the tool body, and the tool terminal comprises a tool terminal machining surface and a tool terminal primary inner flow path outlet;
a tool machining structure, positioned on the exterior of the tool body, and the tool machining structure avoids the tool terminal primary inner flow path outlet and extends along the tool terminal machining surface, wherein the tool terminal and the tool machining structure are integrally formed; and
a tool primary inner flow path, penetrating the tool body and extending to the tool terminal primary inner flow path outlet in the interior of the too body, and the tool primary inner flow path comprises a primary inner flow path spiral structure; wherein,
the tool body can be positioned close to the workpiece to form an EDM discharge channel between the tool body and the workpiece, allowing the tool machining structure to perform electrical discharge machining on the workpiece in the EDM discharge channel, wherein, a debris is produced in the EDM discharge channel while the tool machining structure performs electrical discharge machining on the workpiece;
the tool primary inner flow path can guide the primary portion of the EDM fluid to flow within it; and
the tool primary inner flow path spiral structure can change the flow speed and flow direction of the primary portion of the EDM fluid, causing the primary portion of the EDM fluid to deviate from the flow direction of the tool primary inner flow path, and the flow direction of the tool primary inner flow path is inclined related to the extension direction of the tool axis, allowing the primary portion of the EDM fluid to generate a primary inner flow path flow field in the tool primary inner flow path, thereby forming the flow driving the debris out of the EDM discharge channel via the primary inner flow path flow field, wherein the tool primary inner flow path comprises a primary inner flow path body, a primary inner flow path inlet section, and a primary inner flow path outlet section, and the two ends of the tool primary inner flow path body are respectively connected to the tool primary inner flow path inlet section and the tool primary inner flow path outlet section, allowing the primary portion of the EDM fluid flows into the tool primary inner flow path body through the tool primary inner flow path inlet section and exits the tool primary inner flow path body through the tool primary inner flow path outlet section and the tool terminal primary inner flow path outlet, and the tool primary inner flow path spiral structure is located in the tool primary inner flow path outlet section, and the cross-sectional area of the tool primary inner flow path inlet section is larger than that of the tool primary inner flow path outlet section.

2. The tool of claim 1, wherein the tool further comprises a tool secondary inner flow path, and the tool terminal further comprises a tool terminal secondary inner flow path outlet, and the tool secondary inner flow path penetrates the tool body and extending to the tool terminal secondary inner flow path outlet in the interior of the tool body, and the tool machining structure is arranged to avoid the tool terminal secondary inner flow path outlet and extends on the tool terminal machining surface, and the tool secondary inner flow path comprises a secondary inner flow path spiral structure, and the secondary inner flow path spiral structure is separate from the tool primary inner flow path spiral structure;
the tool secondary inner flow path can direct the secondary portion of the EDM fluid within it; and
the secondary inner flow path spiral structure can change the flow speed and flow direction of the secondary portion of the EDM fluid, causing the secondary portion of the EDM fluid to deviate from the flow direction of the tool secondary inner flow path, and the flow direction of the tool secondary inner flow path is inclined related to the extension direction of the tool axis, allowing the secondary portion of the EDM fluid to generate a secondary inner flow path flow field in the tool secondary inner flow path, thereby forming the flow driving the debris out of the EDM discharge channel via the secondary inner flow path flow field.

3. The tool of claim 2, wherein the tool secondary inner flow path comprises a secondary inner flow path body, a secondary inner flow path inlet section, and a secondary inner flow path outlet section, and the two ends of the secondary inner flow path body are respectively connected to the secondary inner flow path inlet section and the secondary inner flow path outlet section, allowing the secondary portion of the EDM fluid to flow into the secondary inner flow path body through the secondary inner flow path inlet section and exit the secondary inner flow path body through the secondary inner flow path outlet section and the tool terminal secondary inner flow path outlet, and the secondary inner flow path spiral structure is located within the secondary inner flow path outlet section, and the cross-sectional area of the secondary inner flow path inlet section is larger than the cross-sectional area of the secondary inner flow path outlet section; the tool primary inner flow path inlet section and the secondary inner flow path inlet section are communicable, wherein the total cross-sectional area at the junction of the tool primary inner flow path inlet section and the secondary inner flow path inlet section is larger than the total cross-sectional area of the tool primary inner flow path outlet section and the secondary inner flow path outlet section.

4. The tool of claim 1, further comprising a tool outer flow path, and the tool outer flow path is installed on the exterior of the tool body, and the tool outer flow path comprises an outer flow path guiding structure, and the outer flow path guiding structure comprises a debris channel, and the outer flow path guiding structure is capable of changing the flow speed and flow direction of the EDM fluid within the EDM discharge channel, thereby generating an outer flow path flow field within the EDM discharge channel, thereby forming the flow driving the debris out of the EDM discharge channel via the debris channel, and the debris channel is the groove of the tool body.

5. An electrical discharge machine, the electrical discharge machine being capable of providing an EDM fluid and being equipped with the tool described in claim 1 for performing electrical discharge machining on a workpiece, the electrical discharge machine comprising:
an EDM spindle, being used for mounting the tool and being capable of moving the tool body close to the workpiece, and the EDM spindle comprises a machining fluid injection structure and a rotational power source; wherein,
the machining fluid injection structure is capable of injecting the primary portion of the EDM fluid into the tool primary inner flow path; and
the rotational power source is capable of rotating the tool, thereby changing the flow speed and flow direction of the primary portion of the EDM fluid, causing the primary portion of the EDM fluid to deviate from the flow direction of the tool primary inner flow path, and the flow direction of the tool primary inner flow path is inclined related to the extension direction of the tool axis, allowing the primary portion of the EDM fluid to generate a primary inner flow path flow field in the EDM discharge channel between the tool body of the tool and the workpiece, thereby forming the flow driving the debris generated in the EDM discharge channel out of the EDM discharge channel via the primary inner flow path flow field.

6. A tool, enabling to be equipped with an EDM fluid on an electrical discharge machine to perform electrical discharge machining on a workpiece, comprising:
a tool body, the tool body extending along a tool axis;
a tool machining structure, the tool machining structure being positioned on the exterior of the tool body; and
a tool primary inner flow path, the tool primary inner flow path extending through the interior of the tool body and penetrating the tool body, and the tool primary inner flow path comprises a primary inner flow path straight extension section and at least one primary inner flow path oblique extension section, and the tool primary inner flow path straight extension section is connected to the tool primary inner flow path oblique extension section, and the extension direction of the tool primary inner flow path straight extension section is parallel to the extension direction of the tool axis, and the extension direction of the tool primary inner flow path oblique extension section is inclined relative to the extension direction of the tool axis, and the tool primary inner flow path oblique extension section extends along the tangential direction of a spiral structure; wherein,
the tool body can be positioned close to the workpiece to form an EDM discharge channel between the tool body and the workpiece, allowing the tool machining structure to perform electrical discharge machining on the workpiece in the EDM discharge channel, wherein, a debris is produced in the EDM discharge channel while the tool machining structure performs electrical discharge machining on the workpiece;
the tool primary inner flow path straight extension section can guide the primary portion of the EDM fluid to flow within it; and
the tool primary inner flow path oblique extension section can change the flow speed and flow direction of the primary portion of the EDM fluid, causing the primary portion of the EDM fluid to deviate from the flow direction of the tool primary inner flow path, and the flow direction of the tool primary inner flow path is inclined related to the extension direction of the tool axis, thereby generating a primary inner flow path flow field in the EDM discharge channel, thereby forming the flow driving the debris out of the EDM discharge channel via the primary inner flow path flow field.

7. The tool of claim 6, wherein the tool further comprises a tool secondary inner flow path, the tool secondary inner flow path extending through the interior of the tool body and penetrating the tool body, and the tool secondary inner flow path comprises a secondary inner flow path straight extension section and at least one secondary inner flow path oblique extension section, and the secondary inner flow path oblique extension section avoids the tool primary inner flow path oblique extension section, and the secondary inner flow path straight extension section is connected to the secondary inner flow path oblique extension section, and the extension direction of the secondary inner flow path straight extension section is parallel to the extension direction of the tool axis, and the extension direction of the secondary inner flow path oblique extension section is inclined relative to the extension direction of the tool axis, and the secondary inner flow path oblique extension section extends along the tangential direction of a spiral structure; wherein,
the secondary inner flow path straight extension section can guide the secondary portion of the EDM fluid to flow within it; and
the secondary inner flow path oblique extension section can change the flow speed and flow direction of the secondary portion of the EDM fluid, causing the secondary portion of the EDM fluid to deviate from the flow direction of the tool secondary inner flow path, and the flow direction of the tool secondary inner flow path is inclined related to the extension direction of the tool axis, thereby generating a secondary inner flow path flow field in the EDM discharge channel, thereby forming the flow driving the debris out of the EDM discharge channel via the secondary inner flow path flow field.

8. The tool of claim 6, further comprising a tool outer flow path, and the tool outer flow path is installed on the exterior of the tool body, and the tool outer flow path comprises an outer flow path guiding structure, and the outer flow path guiding structure comprises a debris channel, and the outer flow path guiding structure is capable of changing the flow speed and flow direction of the EDM fluid within the EDM discharge channel, thereby generating an outer flow path flow field within the EDM discharge channel, thereby forming the flow driving the debris out of the EDM discharge channel via the debris channel, and the debris channel is the groove of the tool body.
